(19) United States
(12) Patent Application Publication
(10) Pub. No.: US 2006/0249913 A1
(43) Pub. Date: Nov. 9, 2006

(54) Gapless piston ring for preventing blow-by

(75) Inventor: Eric Nessa, Huntington Beach, CA (US)

Correspondence Address: STETINA BRUNDA GARRED & BRUCKER, 75 ENTERPRISE, SUITE 250, ALISO VIEJO, CA, 92656, US

(73) Assignee: J.E. PISTONS, INC.

(21) Appl. No.: 11/122,427

(22) Filed: May 5, 2005

(51) Int. Cl. F02F 5/00

(52) U.S. Cl. 277/493

(57) ABSTRACT

There is provided a piston ring assembly for eliminating a gas flow path between a piston and a cylinder. The piston ring assembly features a piston ring member forming a natural upper end-gap and a gap seal member forming a natural lower end-gap which are disposable around the piston. The gap seal member has a node that is spaced apart from the natural lower end-gap. The node may be inserted within the natural upper end-gap to retain the gap seal member in place with respect to the piston ring member. This prevents the natural upper and lower end-gaps from becoming aligned with each other so as to eliminate the gas flow path between the piston and the cylinder. The piston ring member may also form a flange which extends normal to a lower ring surface and is circumscribed by the gap seal member when the node is inserted within the natural upper end-gap.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates generally to piston ring assemblies, and more particularly to an improved piston ring assembly which places a node of a gap seal member directly within a natural end-gap of a piston ring member to prevent the end-gaps of both members from becoming aligned, hence providing an effective and long-lasting seal between the piston and the cylinder so as to protect an internal combustion engine against various problems caused by blow-by.

As commonly known, compressed fuel and air mixture burns in the cylinder on the top of the pistons in a typical internal combustion engine. It is important, however, to prevent such mixture from leaking down the piston and escaping into the crankcase. Failure to prevent this phenomenon may result in consequences which may compromise the effectiveness and/or efficiency of the engine.

For instance, leakage down the piston during the engine's compression cycle may lower the effective compression obtained in the cylinder. Such leakage may also create additional emission and pollution problems due to mixture's entrance into the crankcase. In the combustion cycle of the engine, the leakage of the compressed and burning mixture down the piston can reduce the power and efficiency of combustion, not to mention the emission and pollution problems that may result therefrom.

In order to address and resolve the problem of air/fuel mixture leakages, piston rings have been implemented inside a groove around the exterior of the piston to provide a seal between the piston and the interior wall of the cylinder. Typically, the piston rings are not continuously structured, but rather possess natural end-gaps to facilitate their engagement around the exteriors of the pistons. Although these piston rings initially provide a good sealing effect, their repetitive use within the cylinders tend to erode the bottom sides of the piston rings and expand the end-gaps until it becomes necessary to replace them with new ones to prevent blow-by, that is, where the compressed and burning mixtures leak past them and escape into the crankcase.

To address undesirable blow-by, U.S. Pat. No. 3,811,690, which was filed on Sep. 25, 1972 and issued on May 21, 1974 to Maurice J. Moriarty, proposed using an additional ring commonly referred to as a gap seal ring immediately underneath the piston ring to physically obstruct the end-gap altogether. In other words, the use of the additional gap seal ring works to seal the piston ring's end-gap so that any widening of such gap and corroding of the bottom side, would not result in a blow-by.

Because an end-gap also exists in the gap seal ring, the possibility of blow-by cannot be eliminated or even significantly mitigated due to the continuous forceful motion of the piston which causes the gap seal ring to rotate therearound. Over time, there is a tremendous likelihood of the seal ring's end-gap becoming aligned with the end-gap of the piston ring which leads to the compressed fuel and air mixture to seep therethrough, thus undesirably resulting in blow-by.

Another proposal contemplated in the past to eliminate gap alignment is illustrated in U.S. Pat. No. 5,618,048 filed on Aug. 23, 1993 and issued on Apr. 8, 1997 to Maurice J. Moriarty, et al. That patent also proposed utilizing a gap seal ring but with a node-to-socket arrangement. More specifically, a node is provided on the gap seal ring to mate with the corresponding socket formed on the piston ring so that the two parts can immovably hold the rings together and not cause them to rotate with respect to each other. Although such measure may lessen the chances of gap alignment, the manner in which it is done is cost-inefficient, labor-intensive and time-consuming. Simply put, the cost, labor and time to create the socket and the node, and to further fabricate them in a meticulous detail so as to correspond and mate with each other, may be too extensive and troublesome.

In view of the above-described shortcomings of conventional piston ring assemblies, there exists a need in the art for a piston ring assembly that can effectively prevent the gap seal ring from rotating with respect to the piston ring so that their end-gaps do not align with each other and allow blow-by to occur.

### BRIEF SUMMARY OF THE INVENTION

The present invention specifically addresses and alleviates the above-referenced deficiencies associated with the use of the piston ring assemblies of the prior art. More particularly, the present invention is an improved piston ring assembly designed to utilize a natural end-gap of a piston ring member such that it is engaged to a node of a gap seal member to retain relative offset angular positions of the piston ring natural end-gap and a natural end-gap of the gap seal member despite the continuous forceful motion of the host piston. As will be demonstrated below, such feature of the present piston ring assembly prevents the natural end-gaps of its rings from becoming aligned with each other so as to significantly reduce the chances of blow-by.

In accordance with a preferred embodiment of the present invention, there is provided a piston ring assembly for preventing blow-by caused by inadvertent aligning of the rings' natural end-gaps. The present invention relates to the concept of strategically positioning the node of the gap seal member directly within the natural end-gap of the piston ring member rather than modifying or customizing the piston ring member to create a separate accommodating means such as a socket to mate with the node. By capturing the node within the piston ring's natural end-gap, the gap seal member can be desirably immobilized such that its own version of the natural end-gap is consistently stayed apart from that of the piston ring member, hence effectively precluding any potential gap alignment.

In an aspect of the present invention, the piston ring assembly is generally comprised of a piston ring member and a gap seal member. Although various materials and shapes may be employed, the piston ring member and the gap seal member are preferably fabricated from metal such as cast iron or steel, and are generally annular in configuration. Each of the members have a natural end-gap to facilitate their engagement around the piston of an engine such as that belonging to a conventional internal combustion engine.

Upon their engagement around the piston, the outermost surface of the piston ring member extends out toward the interior wall of the cylinder and is placed in abutting contact therewith. Alternatively, the outermost surface of the gap seal member may also extend out to the same degree so that it can collectively abut the cylinder wall with the piston ring member. In either configuration, an effective sealing can be provided between the piston and the cylinder so as to eliminate any gas flow path therebetween.

In another aspect of the present invention, the piston ring member discussed above may also have a flange protruding normal to a lower ring surface along an inner ring surface. The flange may engage the inner seal surface of the seal ring member when the piston and seal ring members are assembled together. The flange may support the seal ring member outward such that the outer ring and seal surfaces may be better able to collectively abut the cylinder wall and eliminate any gas flow path therebetween.

In the present invention, the lowermost surface of the piston ring member is disposed immediately over the uppermost surface of the gap seal member, preferably in abutting contact, so that the two members become stacked on top of one another. This allows the node to extend out toward the piston ring member from the uppermost surface of the gap seal member and be accommodated or trapped within the natural end-gap thereof. As such, the node from the gap seal member becomes confined between the end surfaces of the piston ring member which jointly form its natural end-gap. Preferably, the node is sufficiently spaced apart from the natural end-gap of the gap seal member so that such natural end-gap would not overlap with the natural end-gap of the piston ring member upon the above-described disposal of the node. For example, the node may be angularly offset to the natural end-gap of the gap seal member between about 90° to about 180°, and more preferably, between about 90° to about 120°.

By such specific configuration, the movement of the gap seal member becomes limited due to its upwardly extending node physically abutting and being stopped by the end surfaces of the piston ring member whenever the gap seal member is urged in a particular direction. In this respect, the rotation of the gap seal member relative to the piston ring member is prevented to thereby impede their natural end-gaps from ever aligning with each other. This ensures the elimination of any potential gas flow path through the natural end-gaps of the present piston ring assembly.

In operation, the piston ring assembly is first assembled by stacking the piston ring member over the gap seal member while inserting the node within the natural end-gap formed by the piston ring member. The piston ring assembly is then engaged around the exterior of the piston, and more specifically around the preformed groove provided around the piston's exterior. The preformed groove provided around the piston's exterior restricts separation of the piston ring member from the gap seal member and maintains the node trapped within the natural end-gap of the piston ring member once the piston ring assembly is engaged around the preformed groove. The piston ring assembly is then disposed between the piston and the cylinder.

Upon application of the piston ring assembly, the outermost surface of the piston ring member should extend out to the interior wall of the cylinder so that it effectively seals the spacing therebetween. As mentioned above, the outermost surface of the gap seal member may alternatively be used in conjunction with the piston ring member for such purpose. This eliminates any unwanted gas flow path from being created therethrough. Of course, the node of the gas seal member should remain contained within the natural end-gap of the piston ring member to make sure the natural end-gaps do not become aligned later in time.

### BRIEF DESCRIPTION OF THE DRAWINGS

These as well as other features of the present invention will become more apparent upon reference to the drawings wherein:

FIG. 1 is a perspective exploded view of a piston ring assembly constructed in accordance with a preferred embodiment of the present invention and illustrating its piston ring member and gap seal member which are utilized for providing an effective seal between a piston and a cylinder of an internal combustion engine;

FIG. 2 is a partial cutaway view illustrating the placement of the piston ring assembly of FIG. 1 around the groove of the piston and illustrating the sole abutment of its piston ring member against the wall of the cylinder to provide an effective seal thereabout; and

FIG. 3 is a partial cutaway view illustrating the placement of the piston ring assembly of FIG. 1 around the groove of the piston and illustrating the collective abutment of its piston ring member and the gap seal member against the wall of the cylinder to provide an effective seal thereabout;

FIG. 4 is a partial cutaway view illustrating the placement of the piston ring assembly of FIG. 1 around the groove of the piston and illustrating a flange of the piston ring member against an inner seal surface of the gap seal member;

FIG. 5 is a partial cross sectional view of FIG. 4 illustrating a smaller clearance between the inner ring surface of the piston ring member and exterior wall of the piston compared to the inner seal surface of the gap seal member and an outer flange surface of the piston ring member; and

FIG. 6 is a partial cross sectional view of FIG. 4 illustrating a groove width which is less than the sum of the piston ring member thickness, the gap seal member thickness and the node height.

### DETAILED DESCRIPTION OF THE INVENTION

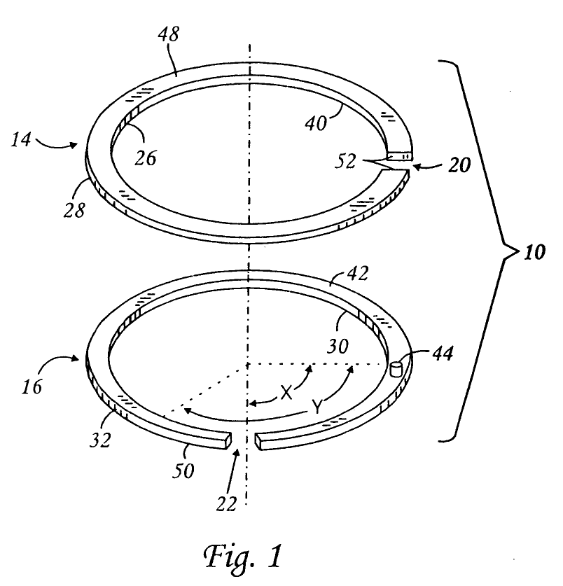

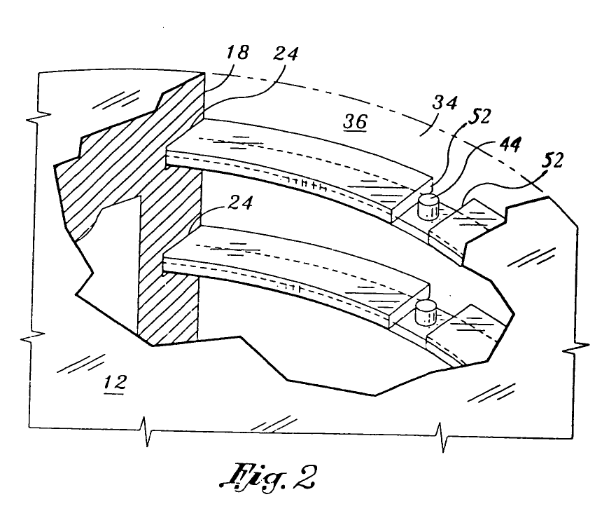

Referring now to the drawings wherein the showings are for purposes of illustrating preferred embodiments of the present invention only, and not for purposes of limiting the same, FIG. 1 perspectively illustrates a piston ring assembly 10 constructed in accordance with a preferred embodiment of the present invention. As indicated above, the present piston ring assembly 10 is designed to employ the use of a piston ring with a natural end-gap together with a gap seal ring that is capable of being substantially secured in position despite the perpetual continuous forceful motion of the host piston 12 (see FIG. 2). As will be soon discussed, this feature of the present invention prevents the natural end-gaps of its rings from becoming aligned with each other to prevent blow-by caused by inadvertent aligning of the rings' natural end-gaps. Surprisingly, the piston ring assembly 10 of the present invention can accomplish such objective in a cost-effective and time-efficient manner due to its ability to use the natural end-gap of the piston ring.

Referring more particularly to FIGS. 1 and 2, the piston ring assembly 10 of the present invention features a piston ring member 14 and a gap seal member 16. The piston ring member 14 and the gap seal member 16 may be manufactured from various rigid materials. However, they are preferably fabricated from a metallic material such as steel, or even a malleable metallic material such as cast iron. Furthermore, although the piston ring member 14 and the gap seal member 16 may have various configurations, they are preferably formed to possess a generally annular or ring configuration so that they may fit around the exterior wall 18 of the piston 12 and more particularly, into a groove 24 formed in the piston exterior wall 18. The piston ring member 14 and the gap seal member 16 may be variably sized depending upon the diameter of the host piston 12. It should be expressly indicated herein that the piston ring assembly 10 of the present invention should not be limited solely to internal combustion engines as its application may extend to other types of engines such as steam engines or pumps.

As with any piston rings, the piston ring member 14 utilized in the present invention includes a preformed natural end-gap 20 which may be referred from now on as the natural upper end-gap. Likewise, the gap seal member 16 is also formed to include its own version of a natural end-gap 22 which may be referred from now on as the natural lower end-gap 22 throughout this section. The natural upper and lower end- gaps 20, 22 facilitate the engagement of the piston ring member 14 and the gap seal member 16 around the groove 24 formed around the exterior wall 18 of the piston 12.

More specifically, the piston ring member 14 has an inner ring surface 26 and an outer ring surface 28. Similarly, the gap seal member 16 has an inner seal surface 30 and an outer seal surface 32. These inner surfaces 26, 30 are fitted within the groove 24 of the piston 12 so that the piston ring member 14 and gap seal member 16 become situated around the exterior wall 18 of the piston 12. When such engagement around the piston 12 is made, the outer ring surface 28 of the piston ring member 14 extends out toward the interior wall 34 of the cylinder 36 so as to be disposed adjacent thereto.

Preferably, the outer ring surface 28 is placed in abutting contact with the interior wall 34 of the cylinder 36. In this regard, the piston ring member 14 should be sufficiently sized to fill the space between the exterior wall 18 of the piston 12 and the interior wall 34 of the cylinder 36. In this specific embodiment, the outer seal surface 32 of the gap seal member 16 should not contact the interior wall 34 of the cylinder and does not extend beyond the boundaries of the outer ring surface 28. Rather, it stays short of the boundaries of the outer ring surface 28. By providing such piston ring member 14, an effective sealing may be implemented between the piston 12 and the cylinder 36 in order to eliminate any gas flow path therebetween.

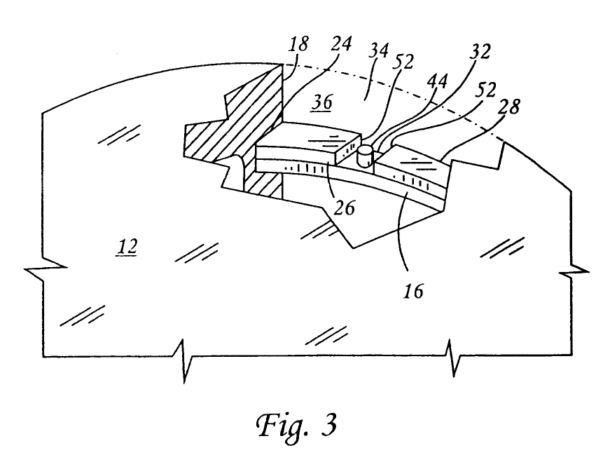

Referring now to FIG. 3 only, an alternative embodiment is illustrated where the outer seal surface 32 of the gap seal member 16 extends out to the same distance as the outer ring surface 28. By such extension, the gap seal member 16 is allowed to be positioned against the interior wall 34 of the cylinder 36, preferably in abutting contact, with the piston ring member 14. Similar to the first described embodiment, this alternative embodiment may also result in an effective sealing between the piston 12 and the cylinder 36 for the purpose of eliminating the gas flow path therebetween.

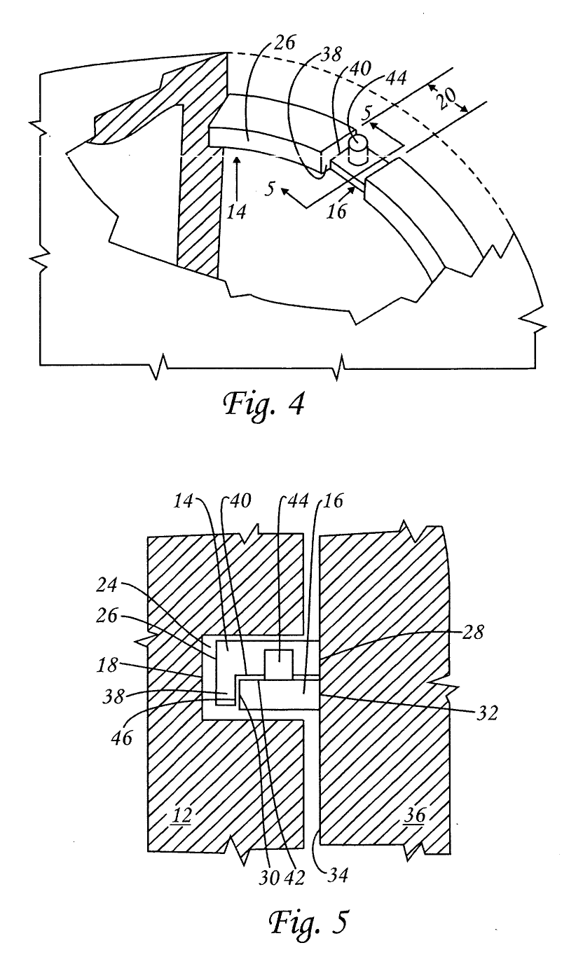

Referring now to FIGS. 4-6 only, another alternative embodiment is illustrated where the piston ring member 14 has a flange 38 which extends normal to a lower ring surface 40 along the inner ring surface 26. The flange 38 is disposed inside the gap seal member 16 and may be urged against the gap seal member 16. Similar to the first and second embodiments, this embodiment may also result in an effective sealing between the piston 12 and the cylinder 36 for the purpose of eliminating the gas flow path therebetween.

Also, similar to the embodiments discussed above, the lower ring surface 40 becomes disposed immediately above and in abutting contact with an upper seal surface 42 of the gap seal member 16 (see FIG. 5) and a node 44 is received into the natural upper end-gap 20 upon assembly of the piston ring assembly 10 (see FIG. 4). In addition, a flange outer surface 46 (see FIG. 5) also becomes disposed immediately adjacent to the inner seal surface 30 and may be in abutting contact therewith. In other words, the gap seal member 16 circumscribes the flange 38.

The piston ring member 14 and the gap seal member 16 may be sized such that their outer ring and seal surfaces 28, 32 extend out coextensively the same distance and collectively abut the interior wall 34 of the cylinder 36 when assembled and engaged to the groove 24, as shown in FIG. 5. Additionally, the inner seal surface 30 and the outer flange surface 46 form a space (i.e., first clearance) which is smaller than a space (i.e., second clearance) formed by the inner ring surface 26 and the exterior wall 18 of the piston. Also, the tolerance of the first clearance is smaller than the tolerance of the second clearance. By way of example and not limitation, the first clearance may be between about 0.000 inches and about 0.002 inches, and the second clearance may be between about 0.005 inches and about 0.010 inches. Accordingly, the gap seal member 16, during running of the internal combustion engine, is urged outwardly by the flange outer surface 46 such that the outer seal surface 32 maintains contact with the interior wall 34 of the cylinder 36 thereby further eliminating blow-by.

Referring now back to FIGS. 1 and 2, the piston ring member 14 comprises an upper ring surface 48 and the lower ring surface 40. Likewise, the gap seal member 16 also has the upper seal surface 42 and a lower seal surface 50. Upon assembling the piston ring assembly 10, the lower ring surface 40 of the piston ring member 14 becomes disposed immediately above the upper seal surface 42 of the gap seal member 16. Preferably, the lower ring surface 40 is rested on the upper seal surface 42 in abutting contact. By such configuration, the piston ring member 14 becomes stacked on top of the gap seal member 16. As will be explained below, this configuration allows the retaining node 44 of the gap seal member 16 to be well retained within the natural upper end-gap 20 of the piston ring member 14.

As illustrated in the figures, the gap seal member 16 may possess the retaining node 44 which is specifically sized and configured to be captured within the natural upper end-gap 20 so as to be substantially immobilized with respect to the piston ring member 14. The reason for such immobilization is to prevent the alignment of the natural upper and lower end- gaps 20, 22 which can undesirably form a gas flow path therethrough and lead to blow-by. However, it is imperative that the retaining node 44 of the gap seal member 16 is captured directly within the natural upper end-gap naturally formed about the piston ring member 14. By capturing the retaining node 44 within the natural upper end-gap 20, the gap seal member 16 remains substantially stationary such that its natural lower end-gap 22 is far removed from the natural upper end-gap 20 of the piston ring member 14 at all times, thus restricting any potential alignment between the two gaps 20, 22.

In particular, the retaining node 44 is formed on the upper seal surface 42 of the gap seal member 16. The retaining node 44 may be a post formed on the upper seal surface 42 or a dimple indented through the gap seal member 16. More particularly, the retaining node 44 extends out toward the lower ring surface 40 of the piston ring member 14 from the upper seal surface 42.

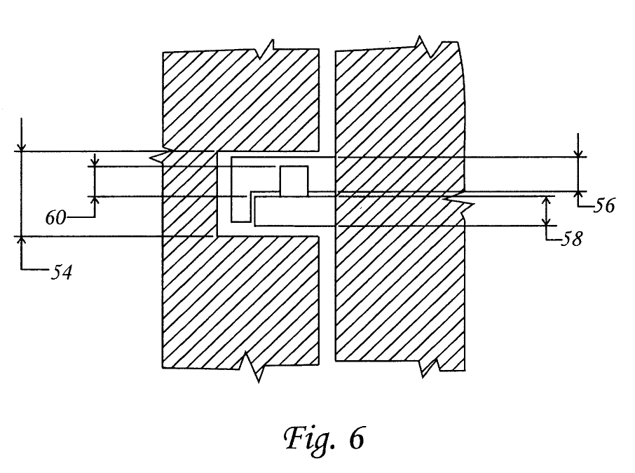

As noted above, the retaining node 44 is then accommodated or trapped within the natural upper end-gap 20. As such, the retaining node 44 becomes confined between two ring end surfaces 52 (see FIGS. 1-3) which define the natural upper end-gap 20 therebetween. The ring end surfaces 52 may be sized and configured to mate with the retaining node 44. For example, each ring surface 52 may have a semi-cylindrical configuration to mate with a cylindrical post or each ring end surface 52 may be flat, as shown in all of the figures. The retaining node 44 remains trapped within the natural upper end-gap 20 once the piston ring assembly 10 is engaged to the groove 24 because, as shown in FIG. 6, the groove width 54 is less than the sum of the piston ring member thickness 56, the gap seal member thickness 58 and the node height 60.

In the preferred embodiment, the retaining node 44 is of a sufficient height which allows it to be positioned well within the natural upper end-gap 20. Also, the width of the retaining node 44 should be narrower than the width of the natural upper end-gap 20 when the piston ring assembly 10 is disposed between the piston 12 and cylinder 36 such that the retaining node 44 may be conveniently inserted into the natural upper end-gap 20. It is important that the retaining node 44 and the natural lower end-gap 22 are sufficiently spaced apart from each other so that the natural lower end-gap 22 does not overlap or coincide in any way with the natural upper end-gap 20 of the piston ring member 14. The retaining node 44 and the natural lower end-gap 22 may be diametrically opposed (180°) to each other. Preferably, they 44, 22 are angularly displaced about 90° to about 120° from each other shown illustratively by “X” and “Y” in FIG. 1. Correspondingly, the angular displacement between the natural upper end-gap 20 and the natural lower end-gap 22 is equal to the angular displacement of the retaining node 44 and the natural lower end-gap 22.

By accommodating and containing the retaining node 44 within the natural upper end-gap 20 in the above-described fashion, the movement of the gap seal member 16 is now restricted. This is due to the upwardly extending retaining node 44 which physically abuts and is stopped by the ring end surfaces 52 of the piston ring member 14 whenever the gap seal member 16 is pushed or urged in a particular direction. As such, the movement or rotation of the gap seal member 16 with respect to the piston ring member 14 is prevented. This has the effect of inhibiting the natural upper and lower end-gaps 20, 22 from ever becoming aligned with each other. Consequently, any gas flow path which may potentially be formed through the aligning of the natural upper and lower end-gaps 20, 22 may be eliminated.

Referring now to all the figures, the operation of the present piston ring assembly 10 can now be illustrated. In operation, the piston ring assembly 10 is first assembled together by mounting or stacking the piston ring member 14 over the gap seal member 16. Simultaneous with such action, the retaining node 44 of the gap seal member 16 is inserted within the existing or preformed natural upper end-gap 20 of the piston ring member 14. The piston ring assembly 10 is then manually engaged around the groove 24 of the piston 12. This disposes the piston ring assembly 10 of the present invention between the exterior wall 18 of the piston 12 and the interior wall 34 of the cylinder 36. Also, if the piston ring assembly 10 is engaged around the piston groove 24 then it is reliable to assume that the retaining node 44 is inserted within the natural upper end-gap 20 because the groove width 54 is too small to receive the piston ring assembly 10 when the retaining node 44 is pressed against the lower seal surface 40 and not inserted within the natural upper end-gap 20.

Upon such engagement of the piston ring assembly 10, the outer ring surface 28 of the piston ring member 14 should extend out to the interior wall 34 of the cylinder 36 so that it effectively seals the spacing between the piston 12 and the cylinder 36. Alternatively, the outer seal surface 32 of the gap seal member 16 may also extend out to the interior wall 34 of the cylinder 36 so as to provide a collective sealing with the piston ring member 14. This eliminates any unwanted gas flow path from being created through the natural upper and lower end-gaps 20, 22. Importantly, the retaining node 44 of the gas seal member 16 remains accommodated within the natural upper end-gap 20 of the piston ring member 14. This ensures that the natural upper and lower end-gaps 20, 22 do not become aligned later in time.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

What is claimed is:

1. A piston ring assembly for eliminating a gas flow path between a piston and a cylinder, the assembly comprising:
a piston ring member disposable around the piston and forming a natural upper end-gap; and
a gap seal member disposable around the piston and forming a natural lower end-gap, the gap seal member having a retaining node spaced apart from the natural lower end-gap and being configured to be inserted within the natural upper end-gap to retain the gap seal member in place with respect to the piston ring member, thereby preventing the natural upper and lower end-gaps from becoming aligned with each other to eliminate the gas flow path between the piston and the cylinder.

2. The assembly of claim 1 wherein the piston ring member and the gap seal member are each fabricated from a metallic material.

3. The assembly of claim 1 wherein the piston ring member and the gap seal member each have a generally annular configuration.

4. The assembly of claim 1 wherein the piston ring member has a lower ring surface and the gap seal member has an upper seal surface, the lower ring surface being disposed over the upper seal surface in abutting contact so as to position the piston ring member on top of the gap seal member.

5. The assembly of claim 1 wherein the gap seal member has an upper seal surface and the retaining node is formed thereon, the retaining node extending upwardly toward the lower ring surface of the piston ring member and being accommodated within the natural upper end-gap thereof.

6. The assembly of claim 1 wherein the piston ring member has two ring end surfaces forming the natural upper end-gap therebetween, the retaining node being confined between the two ring end surfaces.

7. The assembly of claim 6 wherein the retaining node abuts the two ring end surfaces to limit movement thereof within the natural upper end-gap so as to prevent rotation of the gap seal member with respect to the piston ring member.

8. The assembly of claim 1 wherein the piston ring member has an outer ring surface, the outer ring surface being configured to abut the cylinder and provide sealing between the piston and the cylinder so as to eliminate the gas flow path therebetween.

9. The assembly of claim 1 wherein the piston ring member has an outer ring surface and the gap seal member has an outer seal surface, the outer ring surface and the outer seal surface being configured to collectively abut the cylinder and provide sealing between the piston and the cylinder so as to eliminate the gas flow path therebetween.

10. The assembly of claim 1 wherein the natural lower end-gap and the retaining node are about 90° to about 180° angularly displaced to each other.

11. The assembly of claim 1 wherein the piston ring member further forms a flange extending normal to a lower ring surface and the gap seal member circumscribes the flange when the node is inserted into the natural upper end-gap.

12. The assembly of claim 11 wherein the flange is formed along an inner ring surface.

13. The assembly of claim 11 wherein a first clearance defined by an inner seal surface and outer flange surface is smaller than a second clearance defined by an inner ring surface and an exterior wall of the piston.

14. The assembly of claim 13 wherein the first clearance is between about 0.000 inches and about 0.002 inches and the second clearance is between about 0.005 inches and about 0.010 inches.

15. An internal combustion engine, comprising:
a cylinder;
a piston disposed within the cylinder; and
a piston ring assembly, comprising:
a piston ring member disposed around the piston and forming a natural upper end-gap; and
a gap seal member disposed around the piston and forming a natural lower end-gap, the gap seal member having a retaining node spaced apart from the natural lower end-gap and being configured to be inserted within the natural upper end-gap to retain the gap seal member in place with respect to the piston ring member, thereby preventing the natural upper and lower end-gaps from becoming aligned with each other to eliminate the gas flow path between the piston and the cylinder.

16. The engine of claim 15 wherein the piston ring member and the gap seal member are each fabricated from a metallic material.

17. The engine of claim 15 wherein the piston ring member has a lower ring surface and the gap seal member has an upper seal surface, the lower ring surface being disposed over the upper seal surface in abutting contact so as to position the piston ring member on top of the gap seal member.

18. The engine of claim 15 wherein the gap seal member has an upper seal surface and the retaining node is formed thereon, the retaining node extending toward the piston ring member and being accommodated within the natural upper end-gap thereof.

19. The engine of claim 15 wherein the piston ring member has two ring end surfaces forming the natural upper end-gap therebetween, the retaining node being confined between the two ring end surfaces.

20. The engine of claim 19 wherein the retaining node abuts the two ring end surfaces to limit movement thereof within the natural upper end-gap so as to prevent rotation of the gap seal member with respect to the piston ring member.

21. The engine of claim 15 wherein the cylinder has an interior cylinder wall and the piston ring member has an outer ring surface, the outer ring surface abutting the interior cylinder wall to provide sealing between the piston and the cylinder so as to eliminate the gas flow path therebetween.

22. The engine of claim 15 wherein the cylinder has an interior cylinder wall, the piston ring member having an outer ring surface and the gap seal member having an outer seal surface, the outer ring surface and the outer seal surface collectively abutting the interior cylinder wall to provide sealing between the piston and the cylinder so as to eliminate the gas flow path therebetween.

23. The engine of claim 15 wherein the piston has an exterior piston wall forming at least one piston groove therearound, the piston ring member having an inner ring surface and the gap seal member having an inner seal surface, the inner ring surface and the inner seal surface being engaged within the at least one piston groove for engagement to the piston.

24. The engine of claim 15 wherein the piston has an exterior piston wall forming at least one piston groove therearound, the groove defines a groove width which is less than a sum of a piston ring member thickness, gap seal member thickness and a node height.

25. The engine of claim 15 wherein the natural lower end-gap and the retaining node are about 90° to about 180° angularly displaced to each other.

26. A piston ring assembly for eliminating a gas flow path between a piston and a cylinder, the assembly comprising:
a piston ring member disposable around the piston, the piston ring member forming a flange extending normal to a lower ring surface and a natural upper end-gap; and
a gap seal member having a node insertable within the natural upper end-gap, the gap seal member disposable around the piston and circumscribeable around the flange when the node is inserted within the natural upper end-gap.
